(19) United States
(12) Patent Application Publication
(10) Pub. No.: US 2012/0225234 A1
(43) Pub. Date: Sep. 6, 2012

(54) Sticker Structure with an Antibacterial Function

(76) Inventor: Chia-Liang Lin, Taipei City (TW)

(21) Appl. No.: 13/039,436

(22) Filed: Mar. 3, 2011

(51) Int. Cl. C09J 7/04; C09J 7/02

(52) U.S. Cl. 428/40.1

(57) ABSTRACT

A sticker structure includes a plurality of stickers laminating each other. Each of the stickers includes a substrate layer, two thin film layers mounted on two opposite surfaces of the substrate layer, and an adhesive layer mounted on one of the two thin film layers. Thus, the thin film layers of each of the stickers cover the substrate layer completely to form an antibacterial layer on the two surfaces of the substrate layer so as to inhibit growth of bacteria so that when a user's fingers touch the substrate layer of each of the stickers, the antibacterial layer on each of the stickers can isolate the user's fingers from the bacteria so as to protect the user's safety and to prevent transfer or spread of the bacteria.

### BACKGROUND OF THE INVENTION

1. Field of the Invention

The present invention relates to a sticky device and, more particularly, to a sticker structure, such as a post-it and the like.

2. Description of the Related Art

A conventional sticker structure comprises a plurality of stickers laminating each other. Each of the stickers can be repeatedly bonded onto and stripped from a surface, such as a wall, desk, door and the like, to facilitate a user using each of the stickers to provide note and notification functions. However, each of the stickers may be touched by many persons to accumulate bacteria, thereby easily causing danger or sanitary problems to the user, and thereby transferring or spreading the bacteria.

### BRIEF SUMMARY OF THE INVENTION

In accordance with the present invention, there is provided a sticker structure, comprising a plurality of stickers laminating each other. Each of the stickers includes a substrate layer, two thin film layers mounted on two opposite surfaces of the substrate layer, and an adhesive layer mounted on one of the two thin film layers.

Each of the two thin film layers of each of the stickers is made of antibacterial material and is provided with antibacterial agent. The two thin film layers of each of the stickers surround the substrate layer to form an antibacterial layer on the two opposite surfaces of the substrate layer to destroy or inhibit growth of bacteria. The substrate layer of each of the stickers is sandwiched between the two thin film layers. One of the two thin film layers of each of the stickers is sandwiched between the substrate layer and the adhesive layer. Each of the stickers has the same size. The substrate layer of each of the stickers is made of paper material. The adhesive layer of each of the stickers can be stripped and adhered repeatedly.

According to the primary advantage of the present invention, the two thin film layers of each of the stickers cover the substrate layer completely to form an antibacterial layer on the two surfaces of the substrate layer so as to inhibit growth of bacteria so that when a user's fingers touch the substrate layer of each of the stickers, the antibacterial layer on each of the stickers can isolate the user's fingers from the bacteria so as to protect the user's safety and to prevent transfer or spread of the bacteria.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a sticker structure in accordance with the preferred embodiment of the present invention.

FIG. 2 is a perspective view of one of the stickers of the sticker structure as shown in FIG. 1.

FIG. 3 is a partially front cross-sectional view of one of the stickers of the sticker structure as shown in FIG. 2.

FIG. 4 is a schematic operational view of one of the stickers of the sticker structure as shown in FIG. 3.

### DETAILED DESCRIPTION OF THE INVENTION

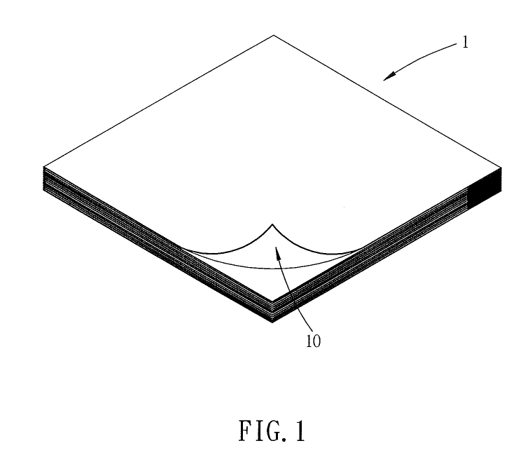

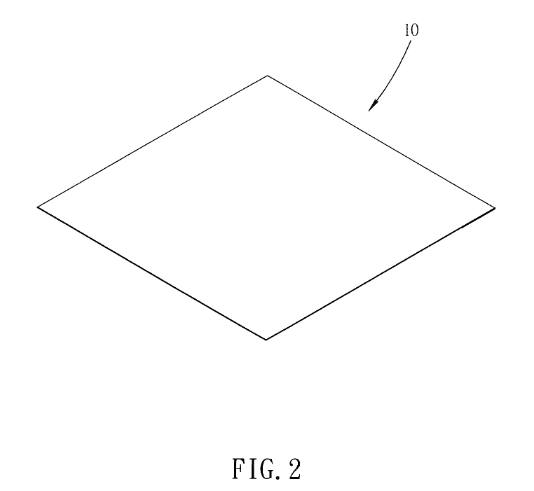

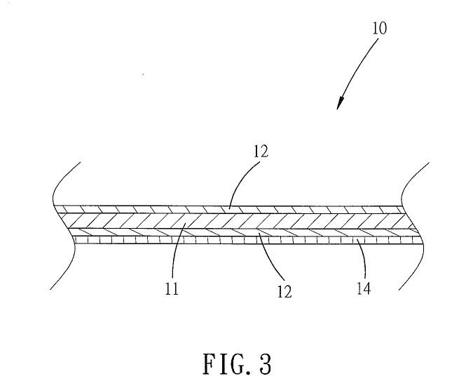

Referring to the drawings and initially to FIGS. 1-3, a sticker structure 1 in accordance with the preferred embodiment of the present invention comprises a plurality of stickers 10 laminating each other.

Each of the stickers 10 has the same size. Each of the stickers 10 includes a substrate layer 11, two thin film layers 12 mounted on two opposite surfaces of the substrate layer 11, and an adhesive layer 14 mounted on one of the two thin film layers 12.

The substrate layer 11 of each of the stickers 10 is made of paper material and is sandwiched between the two thin film layers 12.

Each of the two thin film layers 12 of each of the stickers 10 is made of antibacterial material and is provided with antibacterial agent. The two thin film layers 12 of each of the stickers 10 surround the substrate layer 11 to form an antibacterial layer on the two opposite surfaces of the substrate layer 11 to destroy or inhibit growth of bacteria. One of the two thin film layers 12 of each of the stickers 10 is sandwiched between the substrate layer 11 and the adhesive layer 14. The adhesive layer 14 of each of the stickers 10 can be stripped and adhered repeatedly.

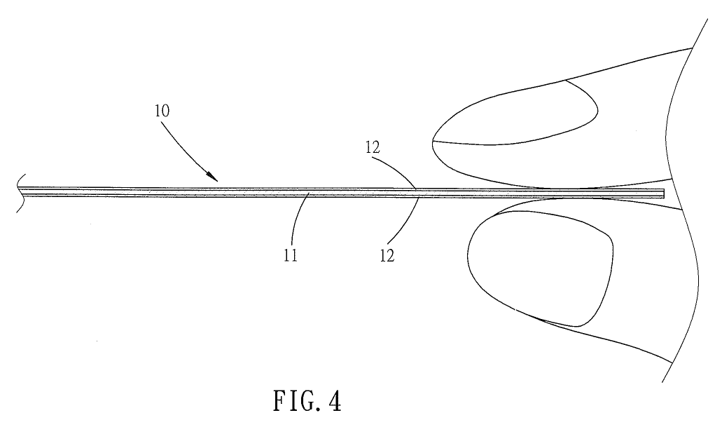

In operation, referring to FIG. 4 with reference to FIGS. 1-3, the thin film layers 12 of each of the stickers 10 form an antibacterial layer on the two opposite surfaces of the substrate layer 11 so as to destroy or inhibit growth of bacteria so that when a user's fingers touch the substrate layer 11 of each of the stickers 10, the antibacterial layer on each of the stickers 10 isolates the user's fingers from the bacteria so as to prevent transfer of the bacteria and to protect the user's safety.

Accordingly, the two thin film layers 12 of each of the stickers 10 cover the substrate layer 11 completely to form an antibacterial layer on the two surfaces of the substrate layer 11 so as to inhibit growth of bacteria so that when a user's fingers touch the substrate layer 11 of each of the stickers 10, the antibacterial layer on each of the stickers 10 can isolate the user's fingers from the bacteria so as to protect the user's safety and to prevent transfer or spread of the bacteria.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A sticker structure, comprising:
a plurality of stickers laminating each other;
wherein each of the stickers includes:
a substrate layer;
two thin film layers mounted on two opposite surfaces of the substrate layer; and
an adhesive layer mounted on one of the two thin film layers.

2. The sticker structure of claim 1, wherein each of the two thin film layers of each of the stickers is made of antibacterial material and is provided with antibacterial agent.

3. The sticker structure of claim 1, wherein the two thin film layers of each of the stickers surround the substrate layer to form an antibacterial layer on the two opposite surfaces of the substrate layer to destroy or inhibit growth of bacteria.

4. The sticker structure of claim 3, wherein the substrate layer of each of the stickers is sandwiched between the two thin film layers.

5. The sticker structure of claim 1, wherein one of the two thin film layers of each of the stickers is sandwiched between the substrate layer and the adhesive layer.

6. The sticker structure of claim 1, wherein each of the stickers has the same size.

7. The sticker structure of claim 1, wherein the substrate layer of each of the stickers is made of paper material.

8. The sticker structure of claim 1, wherein the adhesive layer of each of the stickers can be stripped and adhered repeatedly.
